(19) United States
(12) Patent Application Publication
(10) Pub. No.: US 2023/0099475 A1
(43) Pub. Date: Mar. 30, 2023

(54) DYNAMIC TIME-OUT VALUES FOR OUTBOUND CALLS IN A CLOUD MULTI-TENANT SYSTEM

(71) Applicant: SAP SE, Walldorf (DE)

(72) Inventor: Apoorv Bhargava, Bangalore (IN)

(21) Appl. No.: 17/486,668

(22) Filed: Sep. 27, 2021

(51) Int. Cl. G06F 16/245; G06F 16/2458

(52) U.S. Cl. CPC G06F 16/245; G06F 16/2471

(57) ABSTRACT

In some implementations, there may be provided a method that includes: in response to receiving a request from a client device, initiate, by a cloud service, execution of a process; detecting, by the cloud service, that the process includes a call to a database that is external to the cloud platform; in response to the detecting, requesting, by the cloud service, a time-out value from a time-out value recommendation engine, the time-out value determined based on a state of a cloud platform hosting the cloud service; in response to the request, receiving, by the cloud service, the time-out value determined based on the state of the cloud platform; and performing, based on the time-out value determined based on the state of the cloud platform, the call to the database that is external to the cloud platform. Related systems, methods, and articles of manufacture are also disclosed.

### TECHNICAL FIELD

The present disclosure generally relates to cloud computing.

### BACKGROUND

In a cloud computing environment, multiple tenants can be served by a shared pool of computing resources including, for example, computer networks, servers, storage, applications, services, and/or the like. A tenant can be any entity that requires a secure and exclusive computing environment implemented using the shared pool of computing resources. As such, the multi-tenant cloud computing environment may isolate identity and access management across different tenants as well as segregate tenant-specific data and resources.

### SUMMARY

In some implementations, the current subject matter relates to a computer implemented method. The method may include in response to receiving a request from a client device, initiate, by a cloud service, execution of a process; detecting, by the cloud service, that the process includes a call to a database that is external to the cloud platform; in response to the detecting, requesting, by the cloud service, a time-out value from a time-out value recommendation engine, the time-out value determined based on a state of a cloud platform hosting the cloud service; in response to the request, receiving, by the cloud service, the time-out value determined based on the state of the cloud platform; and performing, based on the time-out value determined based on the state of the cloud platform, the call to the database that is external to the cloud platform.

In some implementations, the current subject matter includes one or more of the following optional features. The call may be a representational state transfer call to the database at another cloud platform that is external to the cloud platform hosting the cloud service. The received time-out value may be modified based on one or more rules. The call may be based on HTTP or HTTPs. The call may include an HTTP or HTTPs GET including a URI indicating the database and the time-out value provided by the time-out value recommender. The time-out value may be determined based on the state of the cloud service at a time when the time-out value is requested. The state of the cloud platform may include one or more of the following: a first indication of available threads; a second indication of available memory; a third indication of available central processing resources; a first quantity of active users at the cloud platform; and a second quantity of active tenants at the cloud platform. The time-out value may be determined by the time-out value recommendation engine based on a machine learning model and a rules engine.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an example of a cloud platform, in accordance with some example implementations of the current subject matter;

FIG. 2 illustrates an example of a call having a fixed time-out value, in accordance with some example implementations of the current subject matter;

FIG. 3 illustrates another example of a cloud platform, in accordance with some example implementations of the current subject matter;

FIG. 4 illustrates an example of a call having a dynamic time-out value, in accordance with some example implementations of the current subject matter;

FIG. 5 illustrates an example of a process using a dynamic time-out value, in accordance with some example implementations of the current subject matter;

FIG. 6A depicts an example of a system operative, in accordance with some example implementations of the current subject matter; and

FIG. 6B depicts another example of a system, in accordance with some example implementations of the current subject matter.

### DETAILED DESCRIPTION

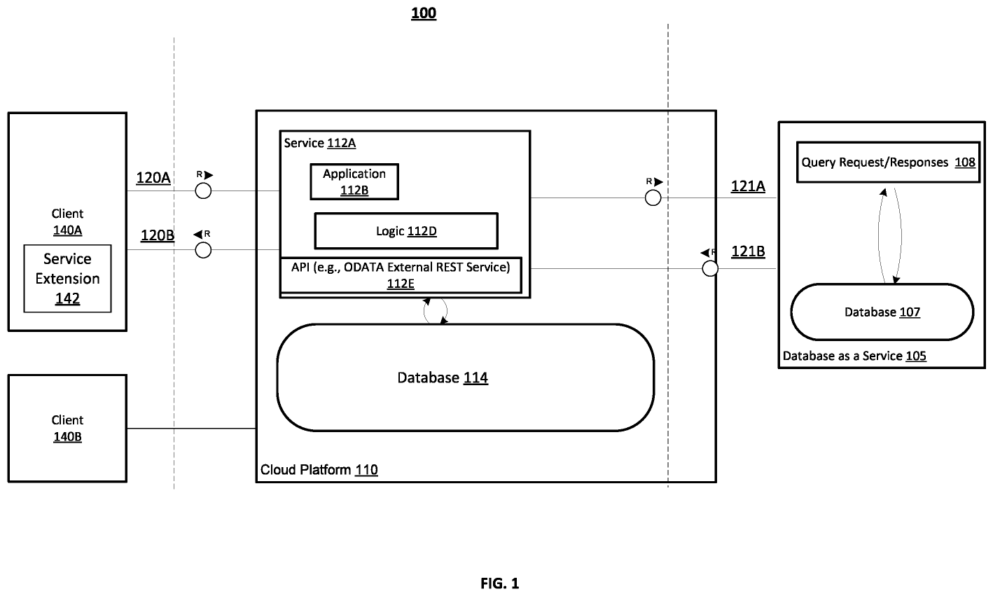

FIG. 1 depicts a diagram illustrating an example of a system 100 consistent with implementations of the current subject matter. Referring to FIG. 1, the system 100 may include a cloud platform 110. The cloud platform 110 may provide resources that can be shared among a plurality of tenants. For example, the cloud platform 110 may be configured to provide a variety of services including, for example, software-as-a-service (SaaS), platform-as-a-service (PaaS), infrastructure as a service (IaaS), and/or the like, and these services can be accessed by one or more tenants of the cloud platform 110. In the example of FIG. 1, the system 100 includes a first tenant 140A (labeled client) and a second tenant 140B (labeled client as well), although other quantities of tenants may be implemented as well as the cloud platform. For example, multitenancy enables multiple end-user devices (e.g., a computer including an application) to access a given cloud service having shared resources via the Internet and/or other type of network or communication link(s).

The cloud platform 110 may include resources, such as at least one computer (e.g., a server), data storage, and a network (including network equipment) that couples the computer(s) and storage. The cloud platform may also include other resources, such as operating systems, hypervisors, and/or other resources, to virtualize physical resources (e.g., via virtual machines), provide deployment (e.g., via containers) of applications (which provide services, for example, on the cloud platform, and other resources). In the case of a “public” cloud platform, the services may be provided on-demand to a client, or tenant, via the Internet. For example, the resources at the public cloud platform may be operated and/or owned by a cloud service provider (e.g., Amazon Web Services, Azure, etc.), such that the physical resources at the cloud service provider can be shared by a plurality of tenants. Alternatively, or additionally, the cloud platform may be a “private” cloud platform, in which case the resources of the cloud platform may be hosted on an entity's own private servers (e.g., dedicated corporate servers operated and/or owned by the entity). Alternatively, or additionally, the cloud platform may be considered a “hybrid” cloud platform, which includes a combination of on-premises resources as well as resources hosted by a public or private cloud platform. For example, a hybrid cloud service may include web servers running in a public cloud while application servers and/or databases are hosted on premise (e.g., at an area controlled or operated by the entity, such as a corporate entity).

In the example of FIG. 1, the cloud platform 110 provides a service 112A to client 140A. This service 112A may be deployed via a container, which provides a package or bundle of software, libraries, configuration data to enable the cloud platform to deploy during runtime the service 112A to, for example, one or more virtual machines that provide the service to client 140A. In the example of FIG. 1, the service 112A is deployed during runtime, and provides an application 112B (which is the runtime application providing the service at 112B). The service 112A may also include logic 112D (e.g., instructions that provide one or more steps of a process), and an interface 112E. The interface may be implemented as an Open Data Protocol (OData) interface (e.g., HTTP message may be used to create a query to an resource identified via a URI), although the interface 112E may be implemented with other types of protocols including those in accordance with REST (Representational state transfer).

In the example of FIG. 1, there are two databases 114 and 105, although other quantities of databases may be implemented as well. The first database 114 is internal to the cloud platform 110, but the second database 105 is external to the cloud platform 110, so an external REST type call, via interface 112E, may be used to send queries and receive responses from database 105. For example, when the interface 112E is configured in accordance with REST or the ODATA protocol), the interface 112E may access a data model, such as the client tenant schema associated with client 140A's data at database 105. And, the interface 112E may provide a REST or ODATA interface to external applications and/or services, which in this case is the database 105. In the case of REST compliant interfaces, the interface 112E may provide a uniform interface that decouples the client and server, is stateless (e.g., a request includes all information needed to process and respond to the request), cacheable at the client side or the server side, and the like.

To illustrate further, the client 140A may cause at 120A execution of a process provided by the service 112A. For example, an action or a condition at client 140A may cause a message 120A querying or requesting a response from the service. For example, the process at the service 112A may generate a document or a report, such as an invoice, which is returned at 120B to the client 140A. In this example, a step of the process may include determining an excise tax for the document or report. When the step requires the determination of the excise tax for example, this may require a query to the external database 105 in order to obtain data regarding excise taxes in different locations. To that end, the service 112A may send 121A a query, via the interface 112E, to the database 105 for excise tax information based on the location associated with the delivery of the product or service, for example. In other words, a REST call is made to an external service, which in this example is database 105. And, the service 112A may receive 121B a response to the query, via the interface 112E, from the database 105 (where the response includes the requested excise tax information based on the location associated with the delivery of the product or service, for example). And, the response may be compliant with REST as well. At least a portion of the noted process may execute at logic 112D at the cloud platform 110 (although a portion may execute at the client 140A as well). Alternatively, or additionally, the noted process for generating the document or report may include a service extension 142 to the service 112A. The service extension may represent a modification in the process (e.g., added step(s) and/or deleted step(s)) specific to, or uniquely for, the client 140A. In other words, the service extension 142 may customize at least a portion of the process for the client 140A. This customization may be shared with other clients (e.g., client 140B and/or the like) or may not be shared with other clients. The sharing may be in accordance with a configuration provided by the client 140A.

When the external call 121A via the interface 112E causes the service 112A to consume too much of the shared resources at the cloud platform 110 (e.g., while waiting for a response by 121B), the request 121A may affect other tenants, such as the client 140B. In other words, if the request 121 consumes too much of the processing capacity of the CPUs, memory, network bandwidth, and the like at the cloud platform 110, this consumption can impact the performance of the services provided by the cloud platform to other tenants, such as client 140B and/or the like. A possible solution to this noted problem may be to restrict the request by setting a fixed time-out value.

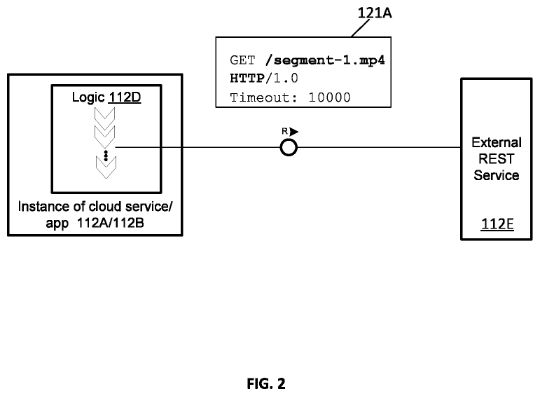

FIG. 2 illustrates an example of a possible solution to the noted problem with the external call 121. In the example of FIG. 2, the call 121A via the interface is implemented with a fixed time-out value. In the example of FIG. 2, the logic 112D may execute one or more tasks, one of which is sending the request 121A, via the external REST service interface 112E, towards the database 105. In this example, the request 121A is a GET with a fixed time-out value of 10000 milliseconds. If the logic 112D does not receive a response to the request 121A (via the external REST service interface 112E) and the fixed time-out value elapses or expires, the logic 112D may trigger a termination of the one or more tasks of the process, so the service 112A may respond at 120B to the client 140A with an error (e.g., a time-out error) rather than an actual desired response value.

The example of FIG. 2 illustrates that the use of a fixed time-out value may not optimize usage of available resources at the cloud platform 110. Indeed, the resources at the cloud platform may vary dynamically at any given time, so a fixed time-out value that is too short (given the available resources at a given time at the cloud platform) may terminate the process too soon (which may merely cause the client to re-send the request) while a fixed time-out value that is too long may not terminate a process that is unfairly consuming too much of the available resources at the cloud platform. For example, if the fixed time-out value is loo long (e.g., 100 seconds or 30 seconds), other tenants may face delay in processing their requests. And, the long running of external calls to the database may block threads for a considerable amount of time, which may be visible in the performance provided to the tenants. Alternatively, if the time-out value is too small (e.g., 200 milliseconds or 50 milliseconds), some calls may time-out, although they would be likely to be successful in generating a response. Thus, there is a need to optimize the time-out value by providing a dynamic time-out value for the external requests, such that the dynamic time-out value takes into account the current, available resources at the cloud platform.

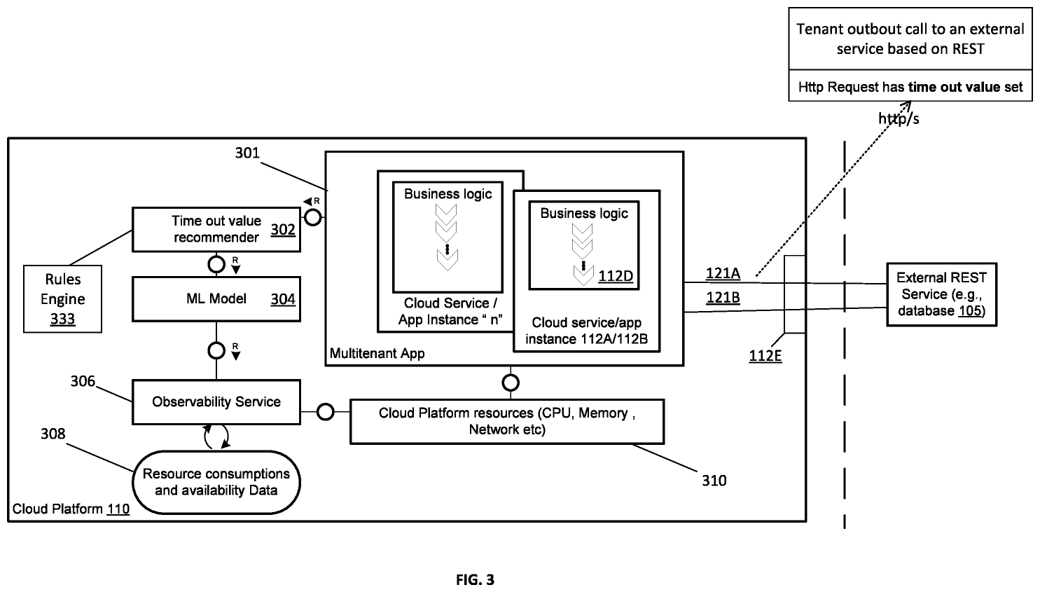

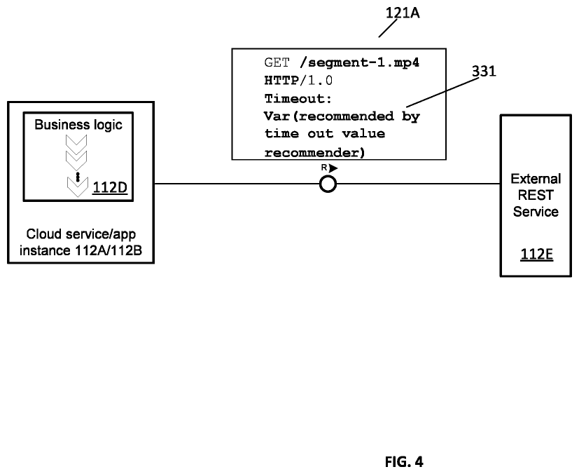

FIG. 3 depicts the cloud platform 110 further configured to include a time-out value recommender 302, a ML model 304, and an observability service 306. In some implementations, the observability service is part of the infrastructure provided to services at the cloud platform. In some implementations, the time out value recommender 302 and ML model may also comprise a service which can be called by applications or services at the cloud platform. The service 112A (labeled cloud service) including application 112B are configured to use a dynamic time-out value provided by the time-out recommender 302. In the example of FIG. 3, the logic 112D may execute a process (e.g., one or more instructions or one or more tasks for application 112B, for example), and one of the instructions or tasks may trigger sending a request or a call 121A, via the external REST service interface 112E, towards the external REST service, such as the database 105. Rather than use a fixed time-out value, the time-out value recommender 302 provides a time-out value for use in the request, such that the time-out value is determined dynamically based on the current state of the resources at the cloud platform. FIG. 4 shows the external call 121A including a dynamic time-out value 331 (labeled “Var”), which is provided by the time-out value recommender 302.

Referring again to FIG. 3, the time-out value recommender 302 may determine the dynamic time-out value 331 based on the current state of the cloud platform 110. For example, the time-out value recommender 302 may access a service, such as observability service 306, to obtain a current state of the cloud platform resources 310. The state of the cloud platform resources 310 may provide an indication of the availability or usage of the CPU(s), the availability or usage of the memory, the availability or usage of the network bandwidth, the availability or usage of the storage, response time to requests, calls, or queries, number of active users, number of active tenants (e.g., virtual machines).

Table 1 below depicts an example of the type of information, which may be obtained from the observability service 306. Referring to Table 1, the observability service 306 may provide one or more of the following: an indication of the currently available quantity of threads (e.g., 50% for the February 1 at 2300 hours); an indication of the currently available memory (e.g., 50% of the total memory at the cloud platform 110 is available at the given time of February 1 at 2300 hours); an indication of the currently available CPU (e.g., 50% of the total CPU at the cloud platform 110 is available at the given time of February 1 at 2300 hours); date and/or time information; quantity of active users at the cloud platform (e.g., 10 user at the given time of February 1 at 2300 hours); and quantity of active tenants at the cloud platform (e.g., 5 tenants at given time of February 1 at 2300 hours).

TABLE 1

| | | | | | | | Qty of |
|---|---|---|---|---|---|---|---|
| | | | | Day Of | Hour of | Qty of | Active |
| Available | Available | Available | Month | the week | the Day | Active | Customers |
| Threads | Memory | CPU | of Year | (1 to 7) | (1 to 24) | users | (or tenants) |
| 50% | 50% | 60% | 2 | 1 | 23 | 10 | 5 |
| | | | (February) | (Monday) | | | |

For example, each containerized cloud service instance may be allowed to use a certain quota (e.g., amount of resources), such as 50% in this example which represents half of that allowed quota for available threads or memory (or 60% of the available CPU). Moreover, a given tenant of a cloud application (or service) may represent a single tenant but that tenant may have a plurality of end users (e.g., client devices) accessing the tenant's subscribed service or application at the cloud platform. To illustrate further, corporation XYZ may represent a tenant of the cloud service but it may have numerous employees or customers (e.g., 50) accessing the tenant's cloud service. While another corporation ABC may represent another tenant at the cloud platform having its group of employees/customers (e.g., 100) using the cloud service. In this example, tenant corporation ABC may only have 5 active users at a given time accessing the cloud service, while XYZ corporation may only have 1 active user, so the quantity of active users would be 6 and the quantity of active tenants is 2. At other times, the quantity of active users and the quantity of active tenants at the cloud platform may change.

When the time-out value recommender 302 receives the current state information for the cloud platform 110 from the observability service 306, the time-out recommender determines the time-out value 331 (see, e.g., FIG. 4). The time-out value is dynamic in the sense that the time-out value is determined based at least in part on the current state (e.g., when the external call is made) of the cloud service provider and/or in response to a given call 121A (or request, query, etc. towards the external service such as the database 105 via the REST interface 112E).

In some implementations, the time-out value recommender 302 determines the time-out value based on a machine learning model 304. For example, the machine learning model may receive, as inputs, the current state information of the cloud platform (information which may be provided by the observability service as noted). The machine learning model may then provide the time-out value 331. As such, the external REST request 121A includes a dynamic time-out value 331. Although some of the examples refer to the request 121A, the request may be in the form of a call or a message via the REST interface 112E as noted above. Because the time-out value 331 is determined based on the current state of the cloud platform, the time-out value 331 may be optimized based on the current state of the cloud platform. When compared to the fixed time-out value described above with respect to FIG. 2, the “optimized” dynamic time-out value 331 (provided by the time-out recommender 302) is more likely to represent a time that does not terminate too soon or does not allow a process to run too long (given the current resources available at the cloud platform).

In some implementations, the time-out value recommender 302 determines the time-out value based on a machine learning model 304. In some implementations, calls made to an internal service (such as database 114 which is internal to the platform 110) would not use the dynamic time out value provided by the time out value recommender 302 but instead use a fixed rule or predetermined value.

Alternative, or additionally, the time-out value recommender 302 may include a rules engine 333 that maps time-out values dynamically based on the current state of the resources available at the cloud platform 110.

In some implementations, the time-out value recommender 302 may receive a recommended time-out value from the machine learning model 304 and/or use the rules engine 333 to determine whether to apply the time-out value provided by the machine learning model 302 or modify or apply another time out value based on a rule at the rules engine. In other words, the rules engine may be used to override of modify the dynamic time out value recommended by the machine learning model 304. For example, given a so-called “premium” tenant, this tenant may need to write more complex and rich logic in external rest service for its requirements. In this example, a rule is set that for this tenant the time out value will be higher, such as 5 seconds. In this case although the ML model predicts the time value is much less (e.g., 2 seconds), a rule at the rules engine 333 may allow 5 seconds based on the rule. In another example, during a holiday season, it may be expected that many more active users will access the cloud service/application so the cloud platform provider may provide additional resources during that time (e.g., number of instances will be doubled) will be assigned for the cloud service/application. To influence the effective time out value, a rule may be set at the rules engine 33 that time out value will be fixed to 5 seconds during this time where there are additional resources.

In some implementations, the machine learning model may receive, as inputs, the current state information of the cloud platform (information that may be provided by the observability service as noted). The machine learning model may then provide the time-out value 331. As such, the external REST request 121A is implemented using a dynamic time-out value 331. As the time-out value 331 is determined based on the current state of the cloud platform 110, the time-out value 331 may be optimized based on the current state of the cloud platform. When compared to the fixed time-out value described above with respect to FIG. 2, the “optimized” dynamic time-out value 331 (provided by the time-out recommender 302) is more likely to represent a time that does not terminate too soon or does not allow a process to run too long (given the current resources available at the cloud platform).

In some implementations, the machine learning model 304 may be trained based on the state of the resources at the cloud platform. Table 2 below depicts an example of the training data, which may be used to train the machine learning model to provide a dynamic time-out value. In the example data of Table 2, the first row shows a given time (in February, for example) when there are relatively ample resources and the quantity active users is less than a threshold quantity of users, so the recommended time-out value of 3 seconds may be higher when compared to the second and third rows. At the second row, there are more active users accessing the cloud platform, so the recommended time-out value is lower when compared to the first row. And, the third row shows that during a certain time (e.g., December) more resources are allocated to the cloud platform 110, so the recommended time-out value is lower when compared to the first two rows.

TABLE 2

| | | | | | | | Qty of | Label - |
|---|---|---|---|---|---|---|---|---|
| | | | | Day Of | Hour of | Qty of | Active | Recommended |
| Available | Available | Available | Month | the week | the Day | Active | Customer | time-out |
| Threads | Memory | CPU | of Year | (1 to 7) | (1 to 24) | users | tenants | value |
| 50% | 50% | 60% | 2 | 1 | 23 | 10 | 5 | 3 seconds |
| | | | (February) | (Monday) | | | | |
| 50% | 50% | 60% | 1 | 1 | 23 | 30 | 5 | 2 seconds |
| | | | (February) | (Monday) | | | | |
| 90% | 80% | 80% | 12 | 1 | 23 | 50 | 5 | 1 seconds |
| | | | (December) | (Monday) | | | | |

Referring to Table 2, the machine learning model 304 may iteratively train until its configuration (e.g., weights) converges to provide the output, which in this example is labelled training data for the dynamic time-out value (e.g., the labeled output in the last column of Table 2). Although Table 2 depicts a certain set of data for training, other types of data may be used to train the machine learning model. Moreover, the machine learning model may be implemented as a neural network, although other types of machine learning models may be used as well (e.g., a regression model to predict the time-out value).

In the example of FIG. 3, the machine learning model 304 may be trained using reference or training data (an example of which is depicted at Table 2). Once trained, the machine learning model 304 may be used to provide the dynamic time-out value based on inputs indicating the state of the resources of the cloud platform 110.

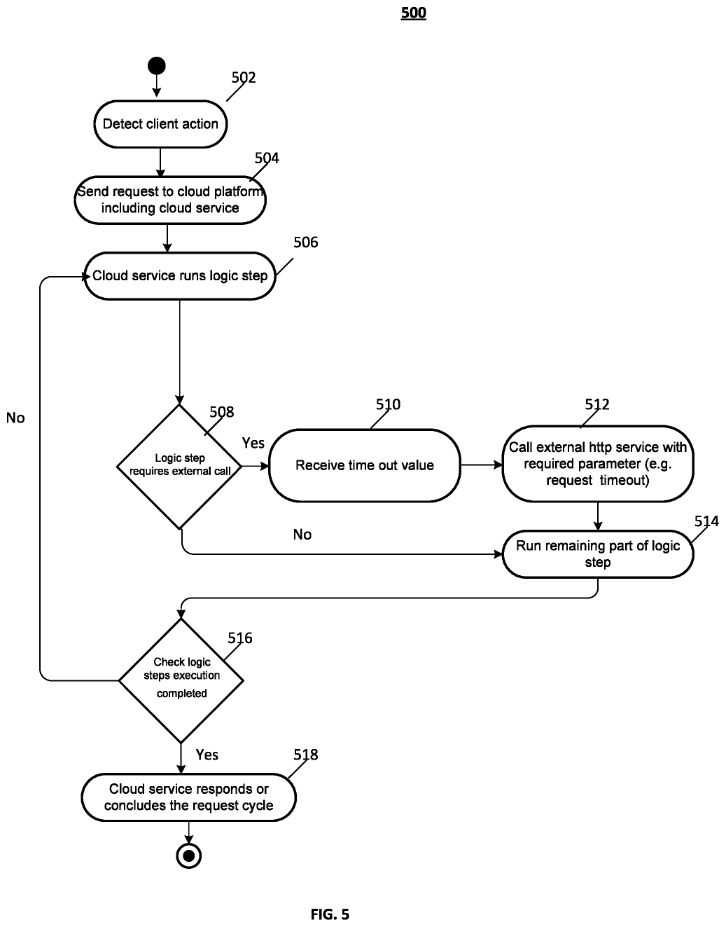

FIG. 5 depicts an example of a process 500 for using a dynamic time-out value, in accordance with some example implementations.

At 502, a client 140A may perform at least a portion of a process including one or more actions (e.g., a task, function, instruction, etc.). For example, a client 140A may select, via a user interface, a user interface element that triggers an action such as generate a report. Alternatively, or additionally, a process at the client 140 may require the service 112A to perform at least one of the actions or tasks of the process. Alternatively, or additionally, a condition at the client may be satisfied (e.g., a rule of the process being satisfied, time of day condition satisfied) triggering an action. The action may be detected by the client 140A. The detected action may also correspond to any action that requires access, by the cloud service 112B or cloud platform 110, to an external service, such as external database 105, such that the access requires an external REST service call (in which case the dynamic time out value recommender may be needed).

In response to the detected action at 502, the client 140A may send a request to the cloud platform 110 including the service 112A (also referred to as a cloud service). The request may be sent in the form of a message, a call, a query, and/or the like. For example, the cloud service 112A may perform at least one action of the process. In response to receiving the request 120A for example, the cloud service 112A (which includes logic 112D for performing at least one action of the process) may initiate execution, at 506, of one or more actions of the process (e.g., one or more logic steps of the logic 112D).

As the one or more actions of the process (e.g., one or more logic steps of the logic 112D) begin to execute at 506, the cloud service 112A may detect that an external call is required (yes at 508). The call may be considered “external” as the call is external to the service 112A, and in this example to an external database. In some embodiments, the external call (which may be in the form of a message, request, and/or query) is an external REST service call which is in accordance with REST as noted above. For example, the external call (or request) may be via an API, such as the interface 112E, and this external call me be implemented as OData interface, in which case the call may be in the form of an HTTP (or HTTPs) message, such as a GET, that queries the database 105 at the URI). An example of the external call is depicted at FIG. 4 at 121A.

At 510, the service 112A may receive the time-out value for the external call. For example, the service 112A may receive the time-out value from the time-out value recommender 302. The time-out value recommender may determine and/or provide the time-out value dynamically based on the current state of the resources at the cloud service provider. The service 112A may receive the time-out value from the time-out value recommender in response to a request to the time-out value recommender and/or in response to the detection of the external call. In some embodiments, the time out value recommender may check one or more rules at the rules engine to determine whether a rule is triggered that overrides or otherwise modifies the time out value provided by the time out value recommender.

At 512, the external call proceeds to an external service, which in this example is an external REST service database 105, such that the external call uses the “dynamic” time-out value provided by the time-out value recommender 302. An example of the external call using the “dynamic” time-out value provided by the time-out value recommender 302 is depicted at FIG. 4 at 121A and 331.

If the process does not time-out (e.g., the database 105 provides a response 121B to the external call 121A during the duration of the time-out value 331), the cloud service 112A receives, at 514, a response 121B and may then continue to run the remaining portion of the process's logic. Referring again to 508, if an external call is not detected in the process's logic flow (No at 508), the cloud service 112A may then run the remaining portion of the process's logic as noted with respect to 514. At 516, the cloud service 112A may check to see if the execution of the service's 112A logic 112D for the process is complete (e.g., the service's 112A portion of the process is complete). If so (Yes at 516), the service 112A may respond, at 518, with a response 120B to the client 140A. This response may provide the data requested at 120A, for example. If not (No at 516), the service 112A may return to 504 to execute another step in the process of the logic 112D.

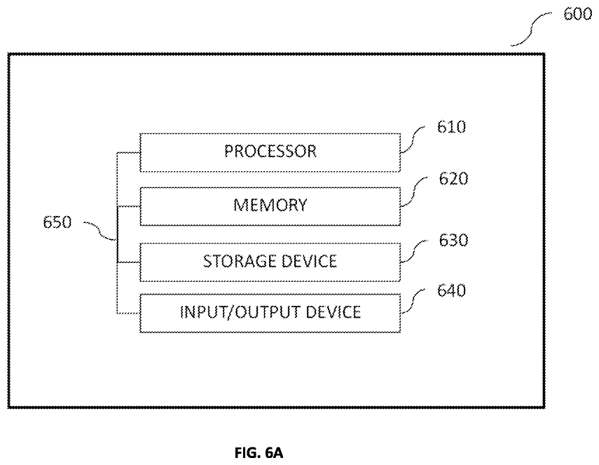

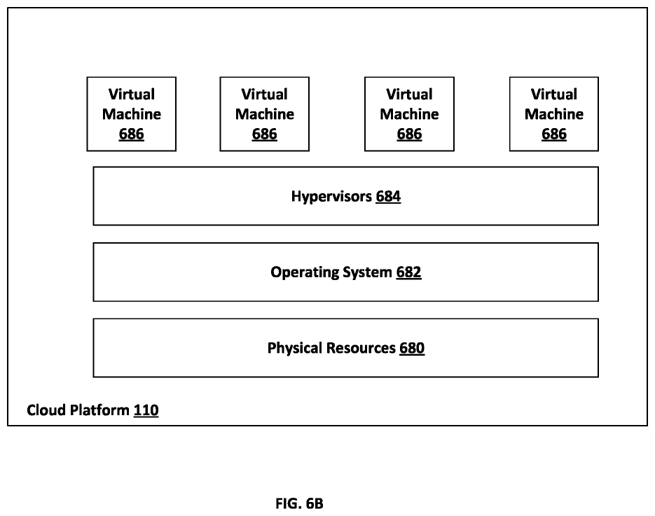

In some implementations, the current subject matter may be configured to be implemented in a system 600, as shown in FIG. 6A. The system 600 may include a processor 610, a memory 620, a storage device 630, and an input/output device 640. Each of the components 610, 620, 630 and 640 may be interconnected using a system bus 650. The processor 610 may be configured to process instructions for execution within the system 600. In some implementations, the processor 610 may be a single-threaded processor. In alternate implementations, the processor 610 may be a multi-threaded processor. The processor 610 may be further configured to process instructions stored in the memory 620 or on the storage device 630, including receiving or sending information through the input/output device 640. The memory 620 may store information within the system 600. In some implementations, the memory 620 may be a computer-readable medium. In alternate implementations, the memory 620 may be a volatile memory unit. In yet some implementations, the memory 620 may be a non-volatile memory unit. The storage device 630 may be capable of providing mass storage for the system 600. In some implementations, the storage device 630 may be a computer-readable medium. In alternate implementations, the storage device 630 may be a floppy disk device, a hard disk device, an optical disk device, a tape device, non-volatile solid state memory, or any other type of storage device. The input/output device 640 may be configured to provide input/output operations for the system 600. In some implementations, the input/output device 640 may include a keyboard and/or pointing device. In alternate implementations, the input/output device 640 may include a display unit for displaying graphical user interfaces.

FIG. 6B depicts an example implementation of the cloud platform 110, which provided the cloud services. The cloud platform 110 may include physical resources 680, such as at least one hardware servers, at least one storage, at least one memory, at least one network interface, and the like. The cloud server may also include infrastructure, as noted above, which may include at least one operating systems 682 for the physical resources and at least one hypervisor 684 (which may create and run at least one virtual machine 686). For example, each multitenant application may be run on a corresponding virtual machine.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in a document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

1. A method, comprising:
in response to receiving a request from a client device, initiate, by a service, execution of a process, wherein the service is implemented at least in part at one or more virtual machines of a cloud platform;
detecting, by the service, that the process includes a call to a database that is external to the cloud platform;
in response to the detecting, requesting, by the service, a time-out value from a time-out value recommendation engine, the time-out value determined based on a state of a cloud platform hosting the service;
in response to the request, receiving, by the service, the time-out value determined based on the state of the cloud platform; and
performing, based on the time-out value determined based on the state of the cloud platform, the call to the database that is external to the cloud platform.

2. The method of claim 1, wherein the call is a representational state transfer call to the database at another cloud platform that is external to the cloud platform hosting the service.

3. The method of claim 1, wherein the received time-out value is modified based on one or more rules.

4. The method of claim 1, wherein the call is based on HTTP or HTTPs.

5. The method of claim 1, wherein the call comprises an HTTP or HTTPs GET including a URI indicating the database and the time-out value provided by the time-out value recommender.

6. The method of claim 1, wherein the time-out value is determined based on the state of the service at a time when the time-out value is requested.

7. The method of claim 1, wherein the state of the cloud platform includes one or more of the following: a first indication of available threads; a second indication of available memory; a third indication of available central processing resources; a first quantity of active users at the cloud platform; and a second quantity of active tenants at the cloud platform.

8. The method of claim 1, wherein the time-out value is determined by the time-out value recommendation engine based on a machine learning model and a rules engine.

9. A system comprising:
at least one processor; and
at least one memory including code which when executed by the at least one processor causes operations comprising:
in response to receiving a request from a client device, initiate, by a service, execution of a process, wherein the service is implemented at least in part at one or more virtual machines of a cloud platform;
detecting, by the service, that the process includes a call to a database that is external to the cloud platform;
in response to the detecting, requesting, by the service, a time-out value from a time-out value recommendation engine, the time-out value determined based on a state of a cloud platform hosting the cloud service;
in response to the request, receiving, by the cloud service, the time-out value determined based on the state of the cloud platform; and
performing, based on the time-out value determined based on the state of the cloud platform, the call to the database that is external to the cloud platform.

10. The system of claim 9, wherein the call is a representational state transfer call to the database at another cloud platform that is external to the cloud platform hosting the service.

11. The system of claim 9, wherein the received time-out value is modified based on one or more rules.

12. The system of claim 9, wherein the call is based on HTTP or HTTPs.

13. The system of claim 9, wherein the call comprises an HTTP or HTTPs GET including a URI indicating the database and the time-out value provided by the time-out value recommender.

14. The system of claim 9, wherein the time-out value is determined based on the state of the service at a time when the time-out value is requested.

15. The system of claim 9, wherein the state of the cloud platform includes one or more of the following: a first indication of available threads; a second indication of available memory; a third indication of available central processing resources; a first quantity of active users at the cloud platform; and a second quantity of active tenants at the cloud platform.

16. The system of claim 9, wherein the time-out value is determined by the time-out value recommendation engine based on a machine learning model and a rules engine.

17. A non-transitory computer-readable medium including code which when executed by at least one processor causes operations comprising:
in response to receiving a request from a client device, initiate, by a service, execution of a process, wherein the service is implemented at least in part at one or more virtual machines of a cloud platform;
detecting, by the service, that the process includes a call to a database that is external to the cloud platform;
in response to the detecting, requesting, by the service, a time-out value from a time-out value recommendation engine, the time-out value determined based on a state of a cloud platform hosting the service;
in response to the request, receiving, by the service, the time-out value determined based on the state of the cloud platform; and
performing, based on the time-out value determined based on the state of the cloud platform, the call to the database that is external to the cloud platform.

18. The non-transitory computer-readable medium of claim 17, wherein the call is a representational state transfer call to the database at another cloud platform that is external to the cloud platform hosting the cloud service.

19. The non-transitory computer-readable medium of claim 17, wherein the received time-out value is modified based on one or more rules.

20. The non-transitory computer-readable medium of claim 17, wherein the state of the cloud platform includes one or more of the following: a first indication of available threads; a second indication of available memory; a third indication of available central processing resources; a first quantity of active users at the cloud platform; and a second quantity of active tenants at the cloud platform.
